(19) United States
(12) Patent Application Publication
(10) Pub. No.: US 2024/0405659 A1
(43) Pub. Date: Dec. 5, 2024

(54) COMPENSATION CIRCUIT FOR TRANSIENT RESPONSE IMPROVEMENT

(71) Applicant: TEXAS INSTRUMENTS INCORPORATED, Dallas, TX (US)

(72) Inventors: Mohamed Ahmed, Merrimack, NH (US); Matthew Schurmann, Wylie, TX (US); Rengang Chen, Center Valley, PA (US)

(21) Appl. No.: 18/326,584

(22) Filed: May 31, 2023

(51) Int. Cl. H02M 1/00; H02M 3/335

(52) U.S. Cl. CPC H02M 1/0048; H02M 3/3353

(57) ABSTRACT

A circuit includes a compensation inductor, a compensation resistor, and a current emulation circuit. The current emulation circuit has a time constant smaller than a time constant of the compensation inductor and the compensation resistor. The current emulation circuit includes a sense resistor having a first terminal coupled with a first terminal of the compensation inductor, and a sense capacitor having a first terminal coupled with a second terminal of the sense resistor and a second terminal coupled with ground.

### TECHNICAL BACKGROUND

With the emerging applications of cloud computing and artificial intelligence, the need for power-hungry microprocessors is increasing. These microprocessors have stringent transient voltage requirements with high current slew rates (many larger than 3000 A/μs). Multi-phase buck converter designs with a plurality of phases are utilized to meet these power requirements. However, due to dense circuit board designs, the addition of more capacitors to reduce transients is not generally possible.

Trans-Inductor Voltage regulator (TLVR) buck converter topology has been used to lower the output capacitance while satisfying higher transient requirements. Due to the nature of these circuits, the inductor current slew rates during transient loading is much higher compared to ordinary buck converter voltage regulators.

The measured currents from the power stages are added inside the controller to create a total current signal. However, due to the very fast transient times of the TLVR buck converters, the individual current sensors are unable to respond as quickly as needed, and the total current signal fails to accurately represent the actual current of the TLVR buck converter.

When the total current signal is used inside the controller compensation loop to achieve an optimal and fast transient response, this difference between the reported currents and the actual currents degrades performance of the control loop and ringing occurs on the output voltage of the buck converter during transient load conditions. This ringing causes the power supplied to the microprocessors to fail their transient voltage requirements.

### SUMMARY

In an implementation, a circuit includes a compensation inductor, a compensation resistor, and a current emulation circuit. The current emulation circuit has a time constant smaller than a time constant of the compensation inductor and the compensation resistor. The current emulation circuit includes a sense resistor having a first terminal coupled with a first terminal of the compensation inductor, and a sense capacitor having a first terminal coupled with a second terminal of the sense resistor and a second terminal coupled with ground.

In another implementation, a circuit includes a buck converter, a compensation inductor, a compensation resistor, and a current emulation circuit. The buck converter includes a Trans-Inductor Voltage regulator (TVLR) transformer having a plurality of secondary coils coupled in series between a ground and a compensation terminal.

The compensation inductor and compensation resistor are coupled in series between the compensation terminal and the ground, and have a compensation time constant. The current emulation circuit has a time constant smaller than the compensation time constant. The current emulation circuit includes a sense resistor having a first terminal coupled with the compensation terminal, and a sense capacitor having a first terminal coupled with a second terminal of the sense resistor and a second terminal coupled with ground.

In a further embodiment, a system includes a buck converter, a controller, a compensation inductor, a compensation resistor, and a current emulation circuit. The buck converter includes a Trans-Inductor Voltage regulator (TVLR) transformer having a plurality of secondary coils coupled in series between a ground and a compensation terminal.

The controller is configured to provide pulse width modulated control signals to the buck converter. The compensation inductor and compensation resistor are coupled in series between the compensation terminal and the ground, and have a compensation time constant.

The current emulation circuit has a time constant smaller than the compensation time constant. The current emulation circuit includes a sense resistor having a first terminal coupled with the compensation terminal, and a sense capacitor having a first terminal coupled with a second terminal of the sense resistor and a second terminal coupled with ground.

### BRIEF DESCRIPTION OF THE DRAWINGS

Many aspects of the disclosure can be better understood with reference to the following drawings. While several implementations are described in connection with these drawings, the disclosure is not limited to the implementations disclosed herein. On the contrary, the intent is to cover all alternatives, modifications, and equivalents.

FIG. 1 illustrates an example buck converter including a Trans-Inductor Voltage regulator (TVLR) transformer.

FIGS. 2A and 2B illustrate actual phase current and reported phase current for the example buck converter of FIG. 1 during load step-up and load step-down.

FIGS. 3A and 3B illustrate actual total current and reported total current for the example buck converter of FIG. 1 during load step-up and load step-down.

FIG. 4A illustrates an example embodiment of a compensation circuit for improving transient response of a buck converter.

FIG. 4B illustrates another example embodiment of a compensation circuit for improving transient response of a buck converter.

FIG. 5 illustrates various signals within the controller of FIG. 4 during steady state operation, for example.

FIG. 6 illustrates various signals within the controller of FIG. 4 during a load step-up transient, for example.

FIG. 7 illustrates various signals within the controller of FIG. 4 during a load step-down transient, for example.

FIG. 8A illustrates an example embodiment of a compensation circuit for improving transient response of a buck converter.

FIG. 8B illustrates another example embodiment of a compensation circuit for improving transient response of a buck converter.

FIGS. 9A and 9B illustrate transient responses of total current during load step-up and load step-down, for example.

FIGS. 10A and 10B illustrate transient responses of voltage across and current through a compensation inductor during load step-up and load step-down with varying time constants of a current emulation circuit, for example.

FIG. 11 illustrates an example embodiment of a compensation circuit for improving transient response of a buck converter including two feedback resistors.

FIG. 12 illustrates gain of a compensation signal generated with different values of the feedback resistors, for example.

FIG. 13 illustrates an example embodiment of a compensation circuit for improving transient response of a buck converter including a compensation capacitor.

FIG. 14 illustrates gain of a compensation signal generated with different values of the compensation capacitor showing varying DC offsets, for example.

### DETAILED DESCRIPTION

The following descriptions of various example embodiments and implementations of a compensation circuit for transient response improvement of buck converters. As discussed above, current sensing and feedback to the controller is critical during transient loading conditions. Due to the nature of TLVR buck converters, inductor slew rates during transient loading are much higher than in normal buck converters. With these fast slew rates existing power stage technology is not capable of reporting accurate current sense signals to the controller curing load transients. Errors in reported current cause the controller to fail to accurately respond to changes in load on the power converter and results in ringing on the output voltage of the power converter.

By adding a RC circuit to the RLVR compensation inductor, the current is sensed with a smaller time constant and this faster feedback is then provided to the controller to compensate for the errors created by the insufficient response time of the sensor.

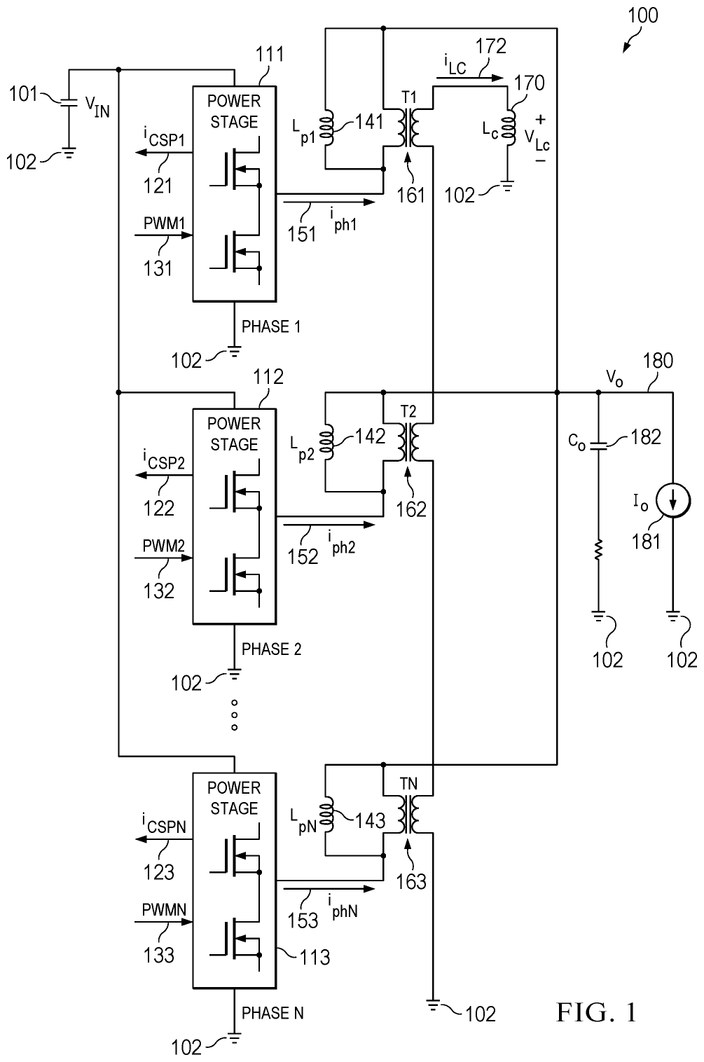

FIG. 1 illustrates an example buck converter including a Trans-Inductor Voltage regulator (TVLR) transformer. In this example embodiment, an N-phase buck converter is illustrated including phase 1 power stage 111, phase 2 power stage 112, through phase N power stage 113. Each power stage is driven by a pulse width modulated (PWM) control signal provided by a controller. Control signals PWM1 131, PWM2 132, through PWMN 133 are illustrated here. Each power stage returns a current sense signal to the controller. Current sense signals i_{CSP1} 121, i_{CSP2} 122, through i_{CSPx} 123 are illustrated here.

The buck converter is powered by Vᵢₙ 101 and is also coupled with ground 102. The output of each phase of the multi-phase buck converter is provided to the Trans-Inductor Voltage regulator (TVLR) transformer, here comprising T1 161, T2 162, through TN 163. The TVLR transformer also includes inductors for each phase of the buck converter, here comprising Lp1 141, Lp2 142, through Lp3 143. The current from each phase of the buck converter is iₚₕ₁ 151, iₚₕ₂ 152, through iphx 153. The output of the buck converter Vₒ 180 is illustrated as applied to a capacitive load Co 182 and has a current of Iₒ 181.

In this example, the secondary coils of the Trans-Inductor Voltage regulator (TVLR) transformer are coupled in series and coupled to a compensation inductor L_{c} 170 at terminal 172. Compensation inductor L_{c} 170 includes a compensation resistor either as a resistance within the inductor or as a discrete component. Current through the compensation inductor is labeled i_{Lc} and the voltage at terminal 172 is labeled V_{Lc}. This voltage at terminal 172 is referred to as a compensation signal. This compensation signal reflects the sum of the current of each phase of the buck converter and is provided to the controller (after modification by the RC circuit described below) to the controller in order to accurately respond to transient changes in load on the buck converter.

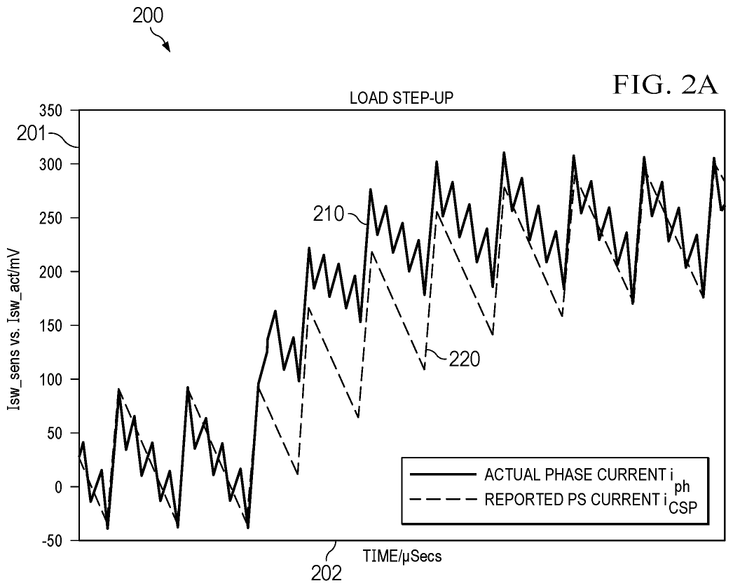

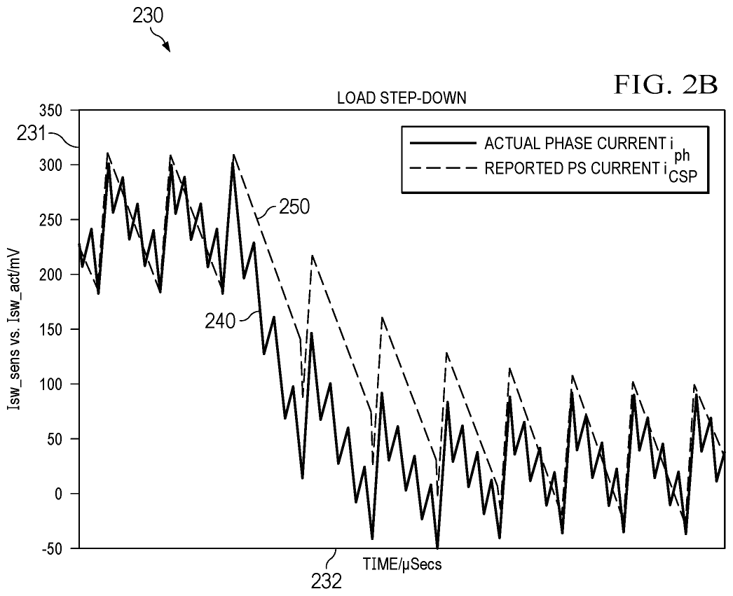

FIGS. 2A and 2B illustrate actual phase current and reported phase current for the buck converter of FIG. 1 during load step-up 200 and load step-down 230 respectively. FIGS. 2A and 2B are simulation results illustrating the difference between actual current and reported current from a single phase of the buck converter of FIG. 1. The vertical axis is current reported as a signal in mV 201 and 231 while the horizontal axis is time in uS 202 and 232.

FIG. 2A shows the difference between actual phase current iₚₕ 210 and reported phase current i_{CSP} 220 for a single stage of the buck converter of FIG. 1 during a load step-up.

FIG. 2B shows the difference between actual phase current iₚₕ 240 and reported phase current i_{CSP} 250 for a single stage of the buck converter of FIG. 1 during a load step-down.

In both cases the reported phase current lags the actual phase current resulting in errors in the control loop within the controller.

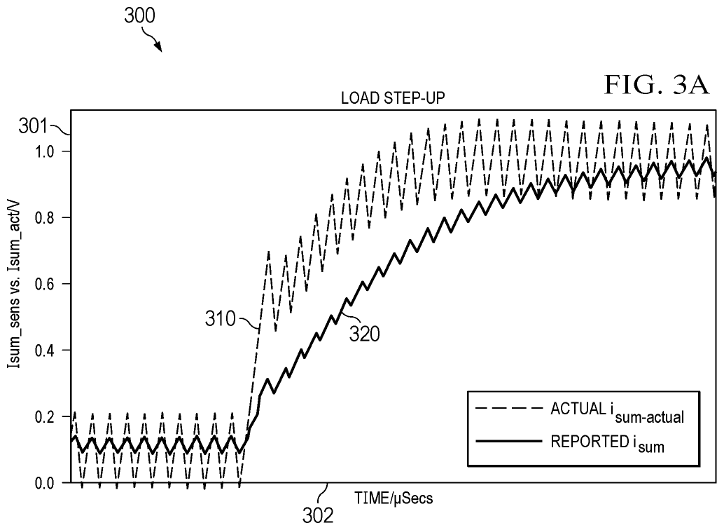

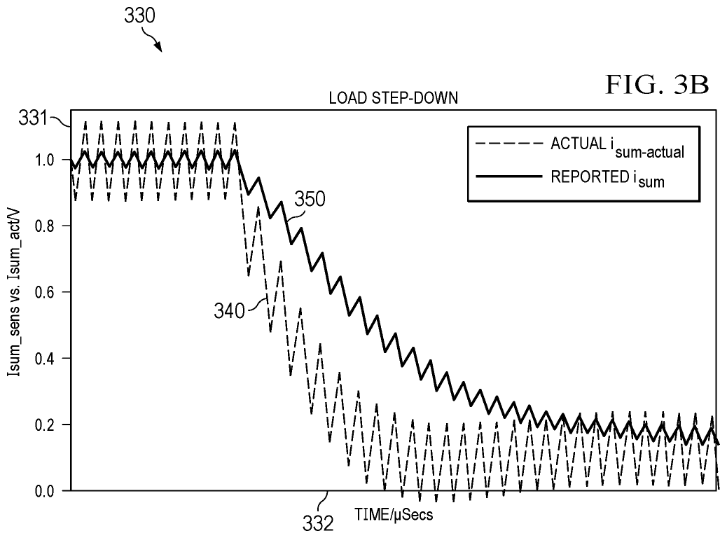

FIGS. 3A and 3B illustrate actual total current and reported total current for the buck converter of FIG. 1 during load step-up 300 and load step-down 330 respectively. FIGS. 3A and 3B are simulation results illustrating the difference between actual total current and reported total current from all phases of the buck converter of FIG. 1. The vertical axis is current reported as a signal in V 301 and 331 while the horizontal axis is time in uS 302 and 332.

FIG. 3A shows the difference between actual total current i_{sum-actual} 310 and reported total current iₛᵤₘ 320 for a single stage of the buck converter of FIG. 1 during a load step-up.

FIG. 3B shows the difference between actual total current i_{sum-actual} 340 and reported total current iₛᵤₘ 250 for a single stage of the buck converter of FIG. 1 during a load step-down.

In both cases the reported total current lags the actual total current resulting in errors in the control loop within the controller. The delay in iₛᵤₘ delays the response of the compensation loop in the controller, resulting in ringing in the output voltage.

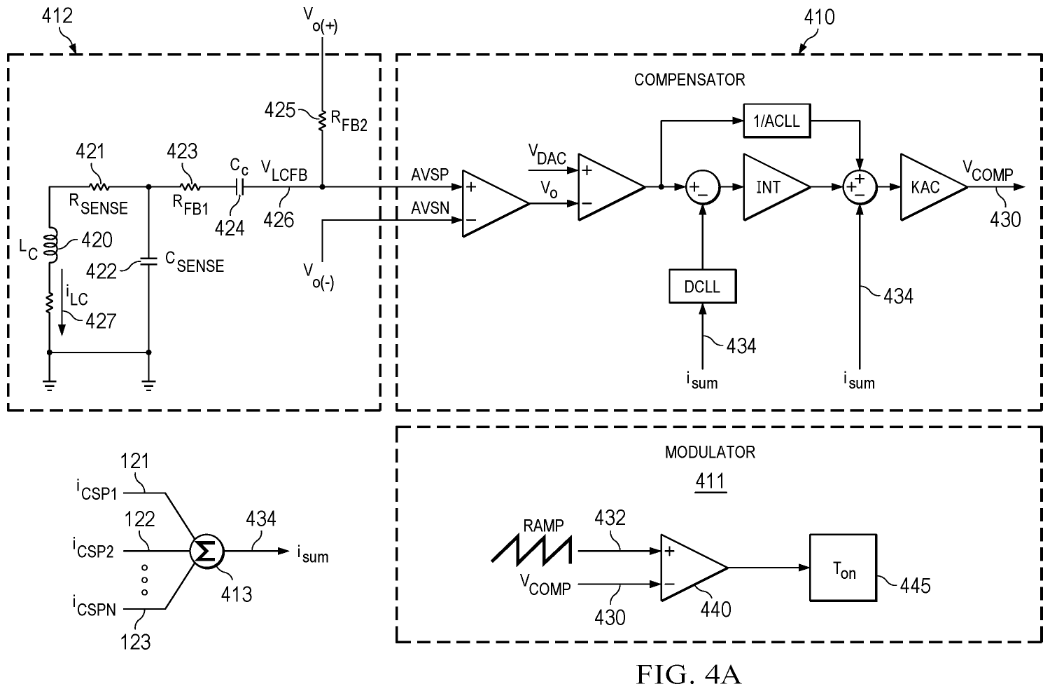

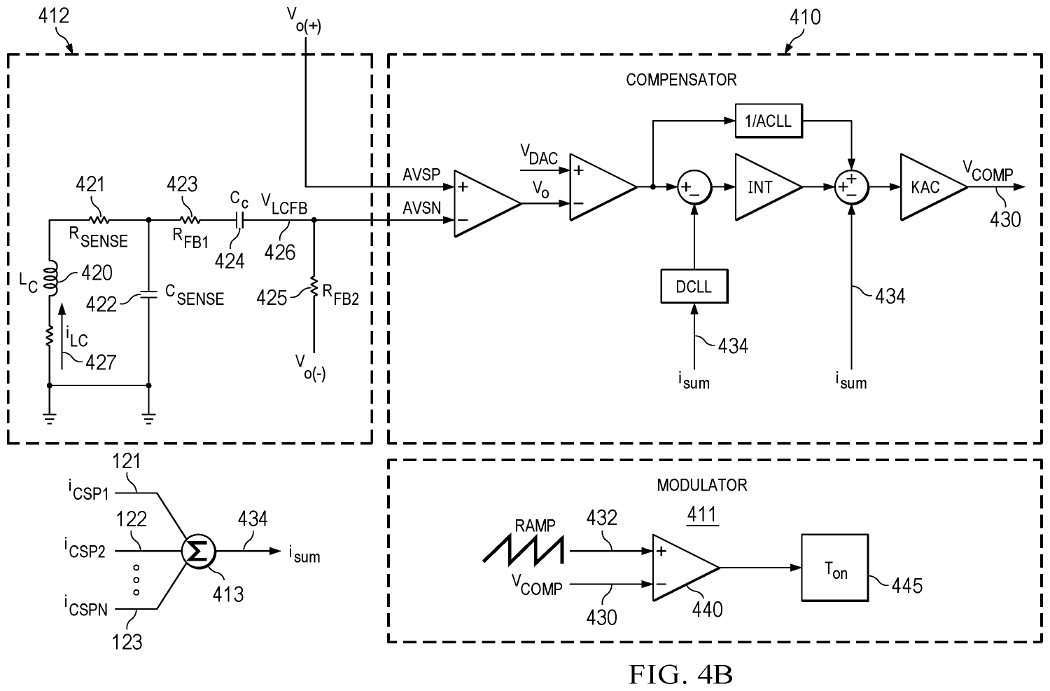

FIG. 4A illustrates an example embodiment of a compensation circuit 412 for improving transient response of a buck converter. In this example, a controller includes a compensator circuit 410 and a modulator circuit 411. Compensation circuit 412 includes the compensation inductor L_{c} 420, equivalent to compensation inductor L_{c} 170 of FIG. 1. Compensation inductor L_{c} 420 includes a compensation resistor and together they have a compensation time constant and a current of i_{Lc} 427. Compensation circuit 412 also includes a current emulation circuit comprising sense resistor Rₛₑₙₛₑ 421, sense capacitor Cₛₑₙₛₑ 422, feedback resistors R_{FB1} 423 and R_{FB2} 425, and compensation capacitor C_{C} 424.

Sense resistor Rₛₑₙₛₑ 421, sense capacitor Cₛₑₙₛₑ 422 have a current emulation time constant. Sense resistor Rₛₑₙₛₑ 421, sense capacitor Cₛₑₙₛₑ 422 are selected such that the current emulation time constant is less than the compensation inductor time constant. Because the current emulation time constant is less than the compensation inductor time constant, the current emulation circuit only modifies the reported power stage current signal for a short time (i.e., during load transients) and does not modify the reported power stage current signal during steady state.

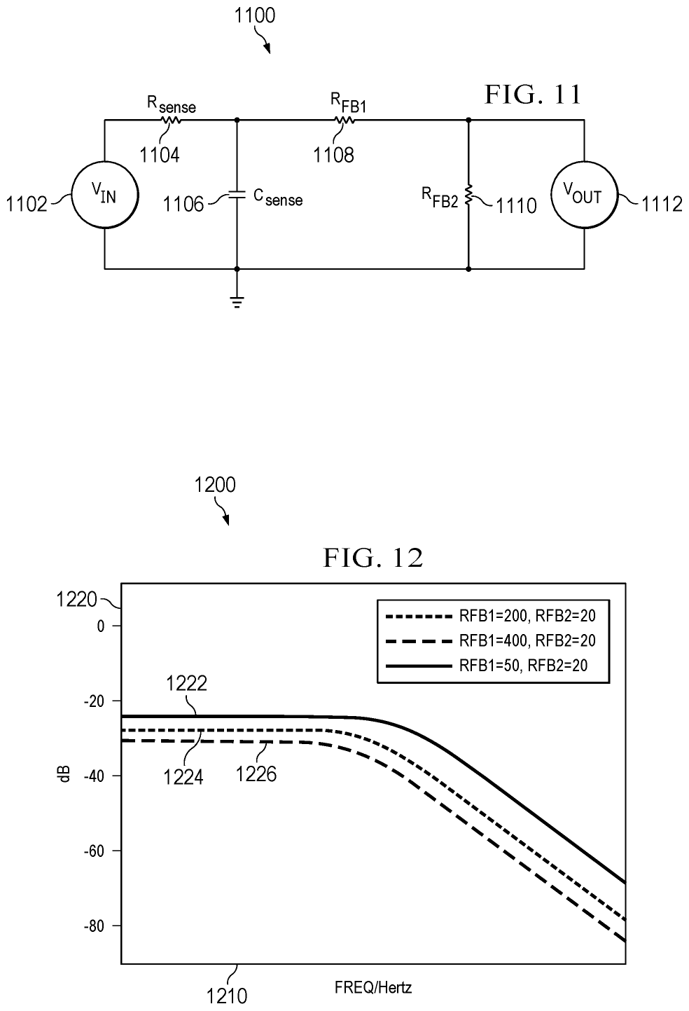

In this example, compensation circuit 412 includes feedback resistors R_{FB1} 423 and R_{FB2} 425 which are selected in order to control a gain of the current emulation of the compensation signal. This functionality of the feedback resistors is illustrated in FIGS. 11 and 12 and described below.

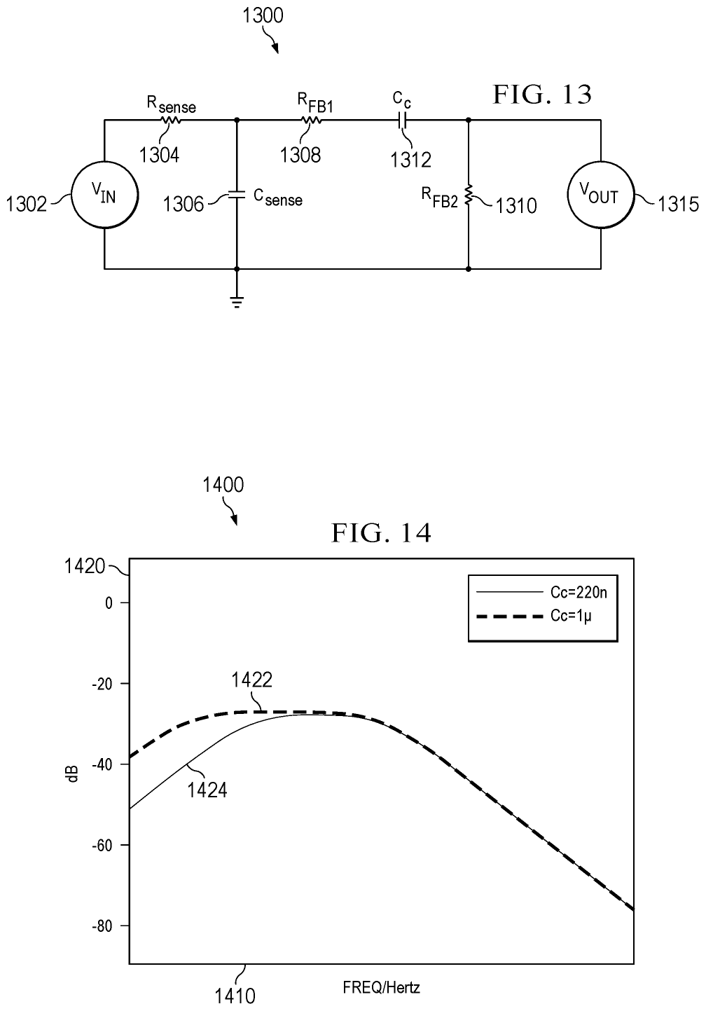

In this example, compensation circuit 412 also includes compensation capacitor C_{C} 424 which is selected to remove a DC offset of the compensation signal. This functionality of the compensation capacitor is illustrated in FIGS. 13 and 14 and described below.

The output of compensation circuit 412 V_{LCFB} 426 is provided to the compensator circuit 410 within the controller. Compensator circuit 410 produces the signal V comp 430 which is then provided to a modulator circuit 411 within the controller. V comp 430 is compared 440 to a RAMP signal 432 (which reduces noise and jitter in pulse width modulators) and the difference is used to control the on time 445 of the PWM signals which are used to control each phase of the buck converter.

This circuit also includes a current summing device 413 adding currents i_{CSP1} 121, i_{CSP2} 122 through i_{CSPN} 123 to produce iₛᵤₘ 434 that is then provided to compensator circuit 410.

FIG. 4B illustrates another example embodiment of a compensation circuit 412 for improving transient response of a buck converter. This embodiment of compensation circuit 412 is identical to that of FIG. 4A but connected to compensator 410 in an opposite polarity configuration. Note that current current i_{LC} 427 flows in the opposite direction to current i_{LC} 427 of FIG. 4A, and that feedback resistor R_{FB2} 425 is now connected to the AVSN input of compensator 410.

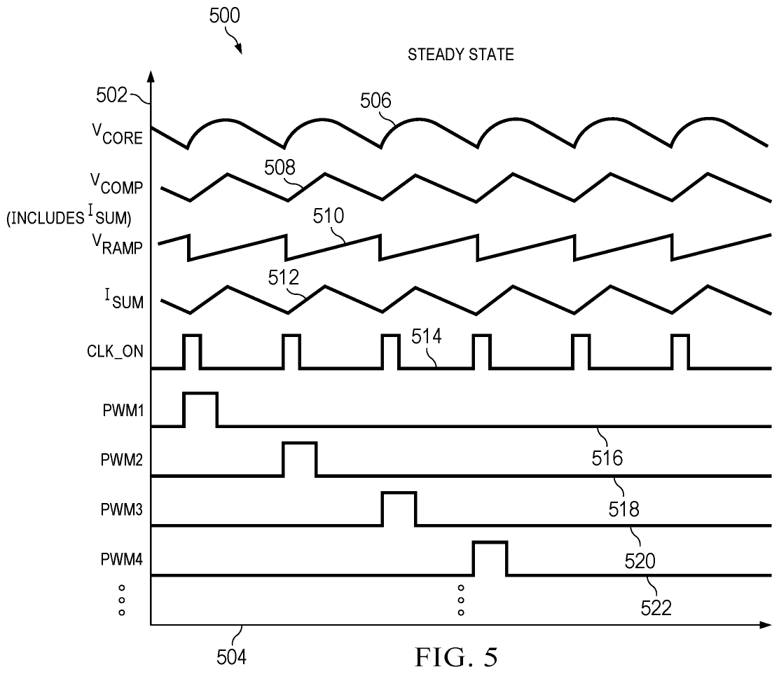

FIG. 5 illustrates various signals within the controller of FIG. 4 during steady state operation 500. In this illustration, voltage is shown in the vertical axis 502 and time along the horizontal axis 504.

Here, V_{CORE} 506 is the CPU core voltage across the final load, V_{COMP} 508 is the output of the compensator circuit 410 of FIG. 4, VRAMP 510 is the RAMP signal 432 of FIG. 4, I_{SUM} 512 is the sum of the currents through all of the phases of the buck converter, CLK_ON 514 is the clock for the plurality of pulse width modulators within the controller (one for each phase of the buck converter), and PWM1 516, PWM2 518, PWM3 520, and PWM4 522 are the pulse width modulator control signals provided to each phase of the buck converter.

During steady state operation, when the load on the buck converter is stable, I_{SUM} and V_{CORE} vary slightly with each phase of the buck converter and the compensation signal V_{COMP} varies slightly with them. No major changes are made to the on time or duty cycle of the pulse width modulators.

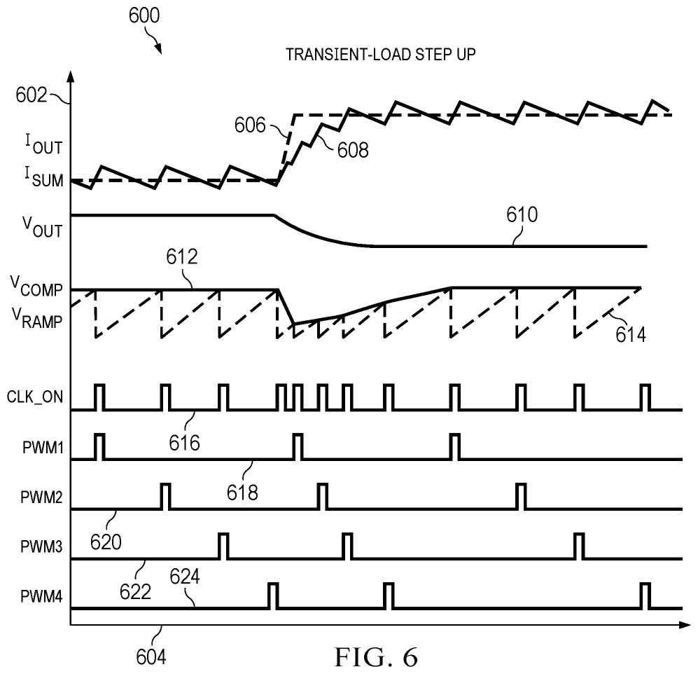

FIG. 6 illustrates various signals within the controller of FIG. 4 during a load step-up transient 600. In this illustration, voltage is shown in the vertical axis 602 and time along the horizontal axis 604.

Here, I_{OUT} 606 is the actual output current of the buck converter (I_{O} 181 in FIG. 1), I_{SUM} 608 is the sum of the outputs of the current sensors within each phase of the buck converter (note that this signal is not able to match the slew rate of the actual output current), V_{OUT} 610 is the actual output voltage of the buck converter (V_{O} 180 in FIG. 1), V_{COMP} 612 is the output of the compensator circuit 410 of FIG. 4, VRAMP 614 is the RAMP signal 432 of FIG. 4, CLK_ON 616 is the clock for the plurality of pulse width modulators within the controller (one for each phase of the buck converter), and PWM1 618, PWM2 620, PWM3 622, and PWM4 624 are the pulse width modulator control signals provided to each phase of the buck converter.

When the load on the output of the buck converter suddenly increases, the output current I_{OUT} 606 rapidly increases to meet the new load, and the output voltage V_{OUT} 610 sags under the increased load. The measured total current I_{SUM} 608 is unable to keep up with the slew rate of the actual output current I_{OUT} 606, so in order to compensate for the delayed response of the current sensors the compensation circuit (412 in FIG. 4) modifies the compensation signal (V_{LCFB} 426 in FIG. 4) which is provided to the compensator circuit 410, which in turn modifies the V_{COMP} 612 signal. This results in changes to the duty cycle of the pulse width modulators during the transient, controlling the phases of the buck converter to accurately account for the change in load during the transient. Since the modified compensation signal corrects for the delay in the measured total current I_{SUM} 608, the buck converter responds to this transient without ringing on the output voltage V_{OUT} 610.

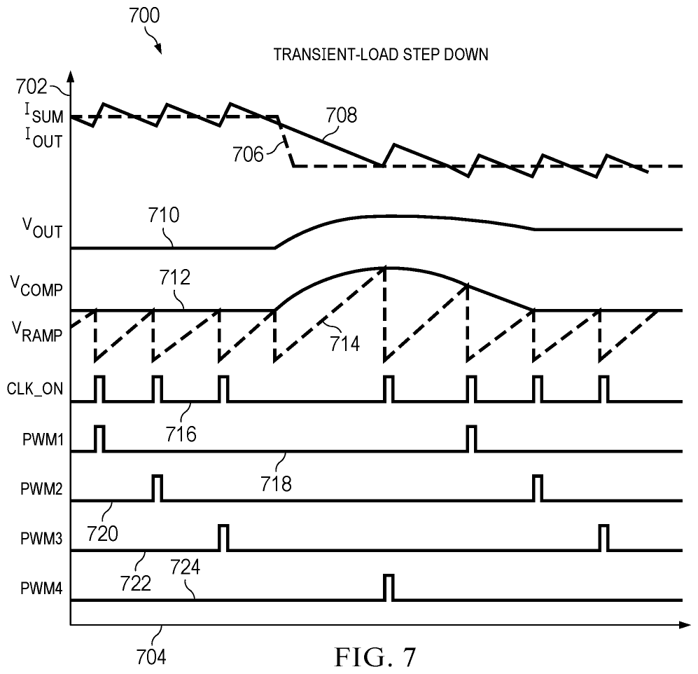

FIG. 7 illustrates various signals within the controller of FIG. 4 during a load step-down transient 700. In this illustration, voltage is shown in the vertical axis 702 and time along the horizontal axis 704.

Here, TOUT 706 is the actual output current of the buck converter (Iₒ 181 in FIG. 1), I_{SUM} 708 is the sum of the outputs of the current sensors within each phase of the buck converter (note that this signal is not able to match the slew rate of the actual output current), VOLT 710 is the actual output voltage of the buck converter (V_{O} 180 in FIG. 1), V_{COMP} 712 is the output of the compensator circuit 410 of FIG. 4, VRAMP 714 is the RAMP signal 432 of FIG. 4. CLK_ON 716 is the clock for the plurality of pulse width modulators within the controller (one for each phase of the buck converter), and PWM1 718, PWM2 720, PWM3 722, and PWM4 724 are the pulse width modulator control signals provided to each phase of the buck converter.

When the load on the output of the buck converter suddenly decreases, the output current I_{OUT} 706 rapidly decreases to meet the new load, and the output voltage V_{OUT} 710 rises under the decreased load. The measured total current I_{SUM} 708 is unable to keep up with the slew rate of the actual output current I_{OUT} 706, so in order to compensate for the delayed response of the current sensors the compensation circuit (412 in FIG. 4) modifies the compensation signal (V_{LCFB} 426 in FIG. 4) which is provided to the compensator circuit 410, which in turn modifies the V_{COMP} 712 signal. This results in changes to the duty cycle of the pulse width modulators during the transient, controlling the phases of the buck converter to accurately account for the change in load during the transient. Since the modified compensation signal corrects for the delay in the measured total current I_{SUM} 708, the buck converter responds to this transient without ringing on the output voltage VOLT 710.

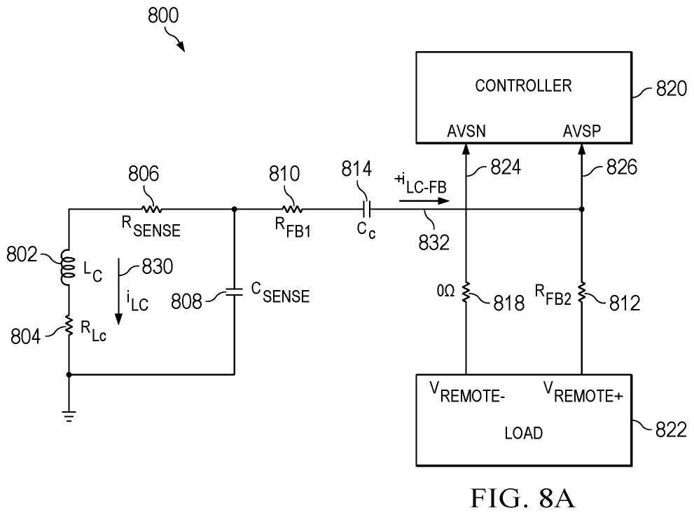

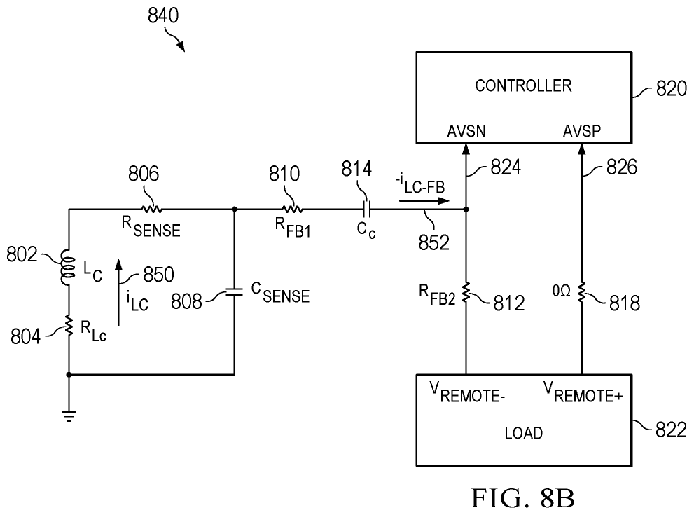

FIG. 8A illustrates an example embodiment of a compensation circuit 800 for improving transient response of a buck converter. In this example, a controller 820 includes differential input terminals AVSN 824 and AVSP 826 coupled with Load 822. Terminal 824 is coupled directly to the load (illustrated as a 0 Ohm resistor 818) and terminal 826 is coupled to the load through feedback resistor R_{FB2} 812. This compensation circuit 800 includes the compensation inductor L_{c} 802, equivalent to compensation inductor L_{c} 170 of FIG. 1, and compensation resistor R_{LC} 804. Together compensation inductor L_{c} 802 and compensation resistor R_{LC} 804 have a compensation time constant and a current i_{Lc} 830. The compensation circuit 800 also includes a current emulation circuit comprising sense resistor Rₛₑₙₛₑ 806, sense capacitor Cₛₑₙₛₑ 808, feedback resistors R_{FB1} 810 and R_{FB2} 812, and compensation capacitor C_{C} 814.

Sense resistor Rₛₑₙₛₑ 806, sense capacitor Cₛₑₙₛₑ 808 have a current emulation time constant. Sense resistor Rₛₑₙₛₑ 806, sense capacitor Cₛₑₙₛₑ 808 are selected such that the current emulation time constant is less than the compensation inductor time constant. Since the current emulation time constant is less than the compensation inductor time constant, the current emulation circuit only has an effect on the reported power stage current signal for a short time (i.e., during load transients) and does not affect the reported power stage current signal during steady state.

In this example, compensation circuit 800 includes feedback resistors R_{FB1} 810 and R_{FB2} 812 which are selected in order to control a gain of the current emulation. This functionality of the feedback resistors is illustrated in FIGS. 11 and 12 and described below.

In this example, compensation circuit 800 also includes compensation capacitor C_{C} 814 which is selected to remove a DC offset of the compensation signal. This functionality of the compensation capacitor is illustrated in FIGS. 13 and 14 and described below.

The output of compensation circuit 800 I_{LC-FB} 806 is provided to the controller 820 at its AVSP input 826. I_{LC-FB} 806 is a voltage corresponding to the current through compensation inductor L_{c} 802 modified by the current emulation circuit comprising sense resistor Rₛₑₙₛₑ 806, sense capacitor Cₛₑₙₛₑ 808, feedback resistors R_{FB1} 810 and R_{FB2} 812, and compensation capacitor C_{C} 814.

The current emulation circuit is added to the compensation inductor L_{c} 802 and compensation resistor R_{LC} 804 in the TLVR circuit, and is designed to have a shorter time constant than the compensation inductor L_{c} 802 and compensation resistor R_{LC} 804 in order to operate only during transient conditions and to avoid impacting steady state operation. The feedback resistors R_{FB1} 810 and R_{FB2} 812 are used to adjust the gain of this signal before adding it to the internal compensation loop. An AC decoupling capacitor, compensation capacitor C_{C} 814, is also added to remove any DC offset between the sensed signal and the added feedback signal due to ground mismatch. The external feedback signal I_{LC-FB} 806 is added to the compensation loop through the differential voltage sense pins to add this information inside the compensation loop and to optimize the transient response.

FIG. 8B illustrates another example embodiment of a compensation circuit 840 for improving transient response of a buck converter. This embodiment of compensation circuit 840 is identical to compensation circuit 800 of FIG. 8A but connected to controller 820 in an opposite polarity configuration. Note that current i_{LC} 850 flows in the opposite direction to current i_{LC} 830 of FIG. 8A, and that feedback resistor R_{FB2} 812 is now connected to the AVSN 824 input of controller 820, and the AVSP 826 input of controller 820 is now connected directly to load 822.

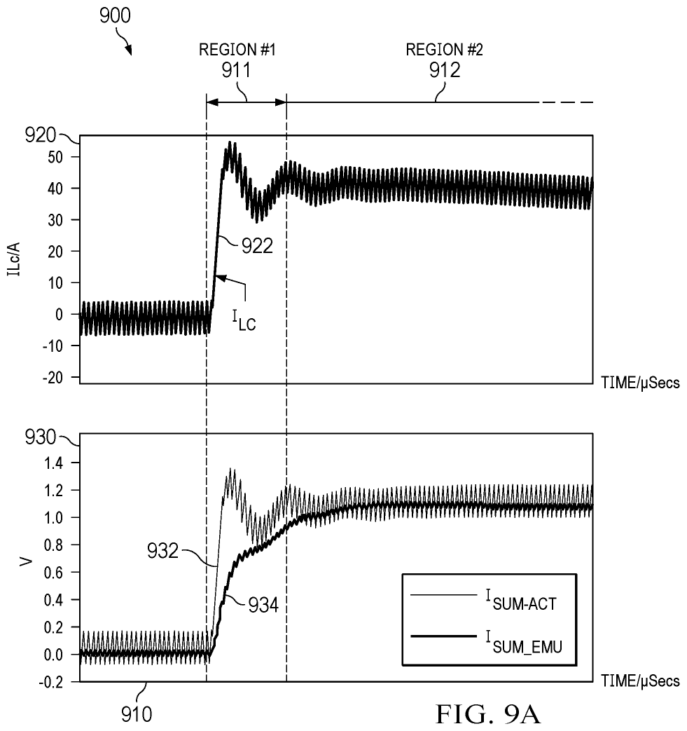

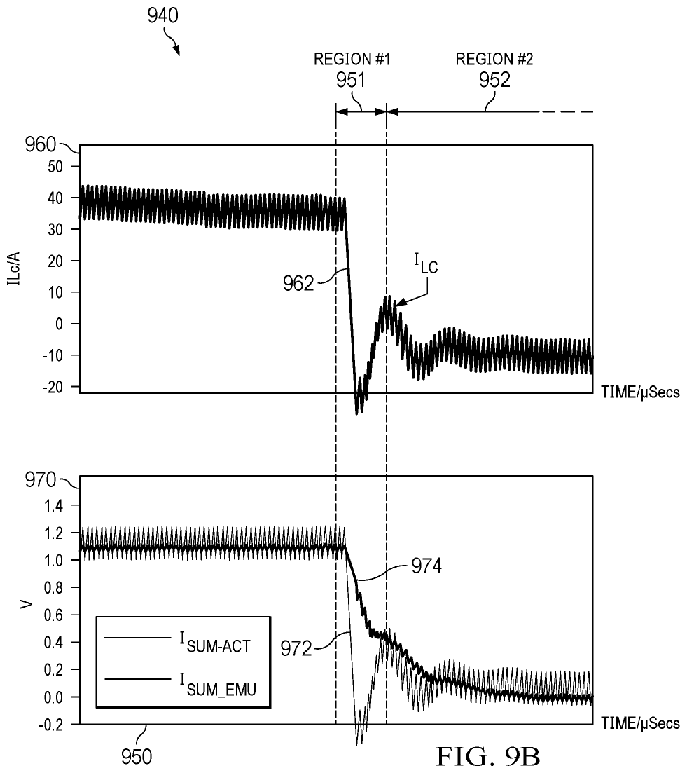

FIGS. 9A and 9B illustrate transient responses of total current during load step-up 900 and load step-down 940. FIG. 9A shows time in uS along the horizontal axis 910 and current I_{LC} 922 through the compensation inductor (L_{C} 170 in FIG. 1) in the vertical axis 920 of the upper simulation and voltage corresponding to total current in the vertical axis 930 of the lower simulation.

In this example, during a sudden increase in load on the buck converter, the current through the compensation inductor I_{LC} 922 rapidly rises to a new steady state after some ringing. The actual total current I_{SUM-ACT} 932 reflects the total current through the compensation inductor I_{LC} 922 while the measured total current I_{SUM} EMC 934 lags the actual current during the transient (Region #1 911) and is accurate during steady state (Region #2 912). Thus, the current emulation circuit only needs to operate during Region #1 911, and not during Region #2 912. This is why the current emulation circuit is designed to have a shorter time constant than the compensation inductor L_{c} 802 and compensation resistor R_{LC} 804, such that it only modifies the compensation circuit during Region #1 911.

FIG. 9B shows time in μS along the horizontal axis 950 and current I_{LC} 962 through the compensation inductor (L_{C} 170 in FIG. 1) in the vertical axis 960 of the upper simulation and voltage corresponding to total current in the vertical axis 970 of the lower simulation.

In this example, during a sudden decrease in load on the buck converter, the current through the compensation inductor I_{LC} 962 rapidly drops to a new steady state after some ringing. The actual total current I_{SUM-ACT} 972 reflects the total current through the compensation inductor I_{LC} 962 while the measured total current I_{SUM} EMU 974 lags the actual current during the transient (Region #1 951) and is accurate during steady state (Region #2 952). Thus, the current emulation circuit only needs to operate during Region #1 951, and not during Region #2 952. This is why the current emulation circuit is designed to have a shorter time constant than the compensation inductor L_{c} 802 and compensation resistor R_{LC} 804, such that it only modifies the compensation circuit during Region #1 951.

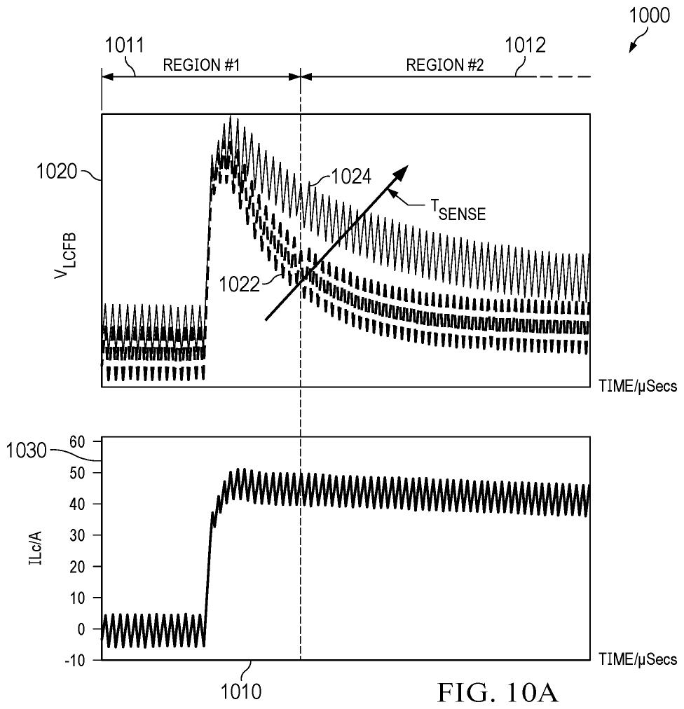

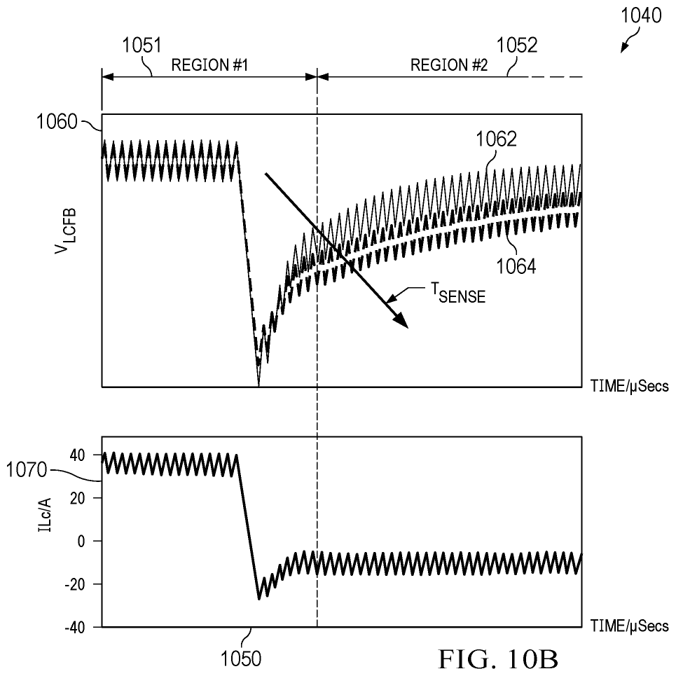

FIGS. 10A and 10B illustrate transient responses of voltage across and current through a compensation inductor during load step-up 1000 and load step-down 1040 with varying time constants of a current emulation circuit.

FIG. 10A shows time in uS along the horizontal axis 1010 and current I_{LC} 1030 through the compensation inductor (L_{c} 170 in FIG. 1) in the lower simulation and the modified compensation signal V_{LCFB} 1020 for varying values of sense resistor Rₛₑₙₛₑ 421, sense capacitor Cₛₑₙₛₑ 422 in the upper simulation.

In this example, two different waveforms 1022 and 1024 of modified compensation signal V_{LCFB} 1020 are illustrated. Waveform 1022 illustrates an embodiment where sense resistor Rₛₑₙₛₑ 421, sense capacitor Cₛₑₙₛₑ 422 have a smaller time constant, while waveform 1024 illustrates an embodiment where sense resistor Rₛₑₙₛₑ 421, sense capacitor Cₛₑₙₛₑ 422 have a larger time constant. When the current emulation time constant is smaller (waveform 1022), the current emulation circuit operates during Region #1 1011 and approaches steady state during Region #2 1012. When the current emulation time constant is large (waveform 1024), the current emulation circuit is operating both during Region #1 1011 and significantly into Region #2 1012.

FIG. 10B shows time in uS along the horizontal axis 1050 and current I_{LC} 1070 through the compensation inductor (L_{c} 170 in FIG. 1) in the lower simulation and the modified compensation signal V_{LCFB} 1060 for varying values of sense resistor Rₛₑₙₛₑ 421, sense capacitor Cₛₑₙₛₑ 422 in the upper simulation.

In this example, two different waveforms 1062 and 1064 of modified compensation signal V_{LCFB} 1060 are illustrated. Waveform 1062 illustrates an embodiment where sense resistor Rₛₑₙₛₑ 421, sense capacitor Cₛₑₙₛₑ 422 have a smaller time constant, while waveform 1064 illustrates an embodiment where sense resistor Rₛₑₙₛₑ 421, sense capacitor Cₛₑₙₛₑ 422 have a larger time constant. When the current emulation time constant is smaller (waveform 1062), the current emulation circuit operates during Region #1 1011 and approaches steady state during Region #2 1012. When the current emulation time constant is large (waveform 1064), the current emulation circuit is operating both during Region #1 1011 and significantly into Region #2 1012.

FIG. 11 illustrates an example embodiment of a compensation circuit 1100 for improving transient response of a buck converter including two feedback resistors 1108 and 1110. In this example, compensation circuit 1100 includes V_{IN} 1102 (the voltage across compensation inductor L_{c} 802 and compensation resistor R_{LC} 804 in FIG. 8), sense resistor Rₛₑₙₛₑ 1104, sense capacitor Cₛₑₙₛₑ 1106, and feedback resistors R_{FB1} 1108 and R_{FB2} 1110. The modified compensation signal is illustrated as Vₒᵤₜ 1112.

FIG. 12 illustrates gain of a compensation signal 1112 generated with different values of the feedback resistors 1108 and 1110. In this example simulation of compensation circuit 1100, gain 1220 is illustrated on the vertical axis while time 1210 is illustrated on the horizontal axis. Waveforms 1222, 1224, and 1226 are shown for three different sets of feedback resistors 1108 and 1110.

Waveform 1222 corresponds to feedback resistor values of 50 Ohms for R_{FB1} 1108 and 20 Ohms for R_{FB2} 1110. Waveform 1224 corresponds to feedback resistor values of 200 Ohms for R_{FB1} 1108 and 20 Ohms for R_{FB2} 1110. Waveform 1226 corresponds to feedback resistor values of 400 Ohms for R_{FB1} 1108 and 20 Ohms for R_{FB2} 1110.

Waveform 1222 has the largest gain, while waveform 1226 has the smallest gain. By selecting the values of feedback resistors R_{FB1} 1108 and R_{FB2} 1110 the gain of the compensation signal is controlled.

FIG. 13 illustrates an example embodiment of a compensation circuit 1300 for improving transient response of a buck converter including a compensation capacitor 1312. In this example, compensation circuit 1300 includes V_{IN} 1302 (the voltage across compensation inductor L_{c} 802 and compensation resistor R_{LC} 804 in FIG. 8), sense resistor Rₛₑₙₛₑ 1304, sense capacitor Cₛₑₙₛₑ 1306, feedback resistors R_{FB1} 1308 and R_{FB2} 1310, and compensation capacitor C_{C} 1312. The modified compensation signal is illustrated as Vₒᵤₜ 1315.

FIG. 14 illustrates gain of a compensation signal 1315 generated with different values of the compensation capacitor C_{C} 1312 showing varying DC offsets. In this example simulation of compensation circuit 1300, gain 1420 is illustrated on the vertical axis while time 1410 is illustrated on the horizontal axis. Waveforms 1422, and 1424 are shown for two different compensation capacitor C_{C} 1312.

Waveform 1422 corresponds to a compensation capacitor value of 1 uF. Waveform 1424 corresponds to a compensation capacitor value of 220 nF. Waveform 1422 has the largest DC offset, while waveform 1424 has the smallest DC offset. By selecting the value of compensation capacitor C_{C} 1312 the DC offset of the compensation signal is controlled.

The included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the invention. Those skilled in the art will also appreciate that the features described above may be combined in various ways to form multiple embodiments. As a result, the invention is not limited to the specific embodiments described above, but only by the claims and their equivalents.

A device that is “configured to” perform a task or function may be configured (e.g., programmed and/or hardwired) at a time of manufacturing by a manufacturer to perform the function and/or may be configurable (or reconfigurable) by a user after manufacturing to perform the function and/or other additional or alternative functions. The configuring may be through firmware and/or software programming of the device, through a construction and/or layout of hardware components and interconnections of the device, or a combination thereof.

A circuit or device that is described herein as including certain components may instead be coupled to those components to form the described circuitry or device. For example, a structure described as including one or more semiconductor elements (such as transistors), one or more passive elements (such as resistors, capacitors, and/or inductors), and/or one or more sources (such as voltage and/or current sources) may instead include only the semiconductor elements within a single physical device (e.g., a semiconductor die and/or integrated circuit (IC) package) and may be coupled to at least some of the passive elements and/or the sources to form the described structure either at a time of manufacture or after a time of manufacture, for example, by an end-user and/or a third-party.

While certain components may be described herein as being of a particular process technology, these components may be exchanged for components of other process technologies. Circuits described herein are reconfigurable to include the replaced components to provide functionality at least partially similar to functionality available prior to the component replacement. Components shown as resistors, unless otherwise stated, are generally representative of any one or more elements coupled in series and/or parallel to provide an amount of impedance represented by the shown resistor. For example, a resistor or capacitor shown and described herein as a single component may instead be multiple resistors or capacitors, respectively, coupled in parallel between the same terminals. For example, a resistor or capacitor shown and described herein as a single component may instead be multiple resistors or capacitors, respectively, coupled in series between the same two terminals as the single resistor or capacitor.

In this description, the term “couple” may cover connections, communications, or signal paths that enable a functional relationship consistent with this description. For example, if device A generates a signal to control device B to perform an action: (a) in a first example, device A is coupled to device B by direct connection; or (b) in a second example, device A is coupled to device B through intervening component C if intervening component C does not alter the functional relationship between device A and device B, such that device B is controlled by device A via the control signal generated by device A.

Uses of the phrase “ground voltage potential” in the foregoing description include a chassis ground, an Earth ground, a floating ground, a virtual ground, a digital ground, a common ground, and/or any other form of ground connection applicable to, or suitable for, the teachings of this description. In this description, unless otherwise stated, “about,” “approximately” or “substantially” preceding a parameter means being within +/−10 percent of that parameter. Modifications are possible in the described examples, and other examples are possible within the scope of the claims.

What is claimed is:

1. A circuit comprising:
a compensation inductor;
a compensation resistor; and
a current emulation circuit having a time constant smaller than a time constant of the compensation inductor and the compensation resistor, wherein the current emulation circuit comprises:
a sense resistor having a first terminal coupled with a first terminal of the compensation inductor; and
a sense capacitor having a first terminal coupled with a second terminal of the sense resistor and a second terminal coupled with ground.

2. The circuit of claim 1, wherein the compensation resistor has a first terminal coupled with a second terminal of the compensation inductor and a second terminal couple with the ground.

3. The circuit of claim 1, wherein the first terminal of the compensation inductor is coupled with a secondary side of a Trans-Inductor Voltage regulator (TVLR) transformer within a buck converter.

4. The circuit of claim 3, wherein the compensation inductor is configured to receive secondary side transformer current from all phases of the buck converter.

5. The circuit of claim 3, wherein the time constant of the current emulation circuit is configured to modify a compensation signal provided by the circuit to a controller with a current emulation signal, wherein the compensation signal is a voltage across the compensation inductor and the compensation resistor, and the controller is configured to provide pulse width modulated control signals to the buck converter.

6. The circuit of claim 5, further comprising a feedback resistor having a first terminal coupled with the second terminal of the sense resistor, configured to control a gain of the modified compensation signal.

7. The circuit of claim 6, further comprising a compensation capacitor having a first terminal coupled with a second terminal of the feedback resistor, configured to remove DC offset from the modified compensation signal.

8. The circuit of claim 7, wherein the compensation signal is configured to determine a modified output voltage of the buck converter that is provided to a compensator circuit within the controller.

9. The circuit of claim 8, wherein the compensator circuit is configured to adjust an on time of the pulse width modulated control signals provided to the buck converter.

10. A circuit comprising:
a buck converter including a Trans-Inductor Voltage regulator (TVLR) transformer having a plurality of secondary coils coupled in series between a ground and a terminal;
an inductor and a first resistor coupled in series between the terminal and the ground having a compensation time constant; and
a current emulation circuit having a time constant smaller than the compensation time constant, wherein the current emulation circuit comprises:
a second resistor having a first terminal coupled with the terminal; and
a capacitor having a first terminal coupled with a second terminal of the second resistor and a second terminal coupled with ground.

11. The circuit of claim 10, wherein the inductor is configured to receive secondary side transformer current from all phases of the buck converter.

12. The circuit of claim 11, wherein the time constant of the current emulation circuit is configured to determine a modification of a compensation signal provided to a controller with a current emulation signal, wherein the compensation signal is a voltage across the inductor and the first resistor, and the controller is configured to provide pulse width modulated control signals to the buck converter.

13. The circuit of claim 12, further comprising a feedback resistor having a first terminal coupled with the second terminal of the second resistor, configured to control a gain of the modified compensation signal.

14. The circuit of claim 13, further comprising a compensation capacitor having a first terminal coupled with a second terminal of the feedback resistor, configured to remove DC offset from the modified compensation signal.

15. The circuit of claim 14, wherein the compensation signal is configured to determine a modified output voltage of the buck converter that is provided to a compensator circuit within the controller.

16. The circuit of claim 15, wherein the compensator circuit is configured to adjust an on time of the pulse width modulated control signals provided to the buck converter.

17. A system comprising:
a buck converter including a Trans-Inductor Voltage regulator (TVLR) transformer having a plurality of secondary coils coupled in series between a ground and a compensation terminal;
a controller configured to provide pulse width modulated control signals to the buck converter;
a compensation inductor and compensation resistor coupled in series between the compensation terminal and the ground having a compensation time constant; and
a current emulation circuit having a time constant smaller than the compensation time constant, wherein the current emulation circuit comprises:
a sense resistor having a first terminal coupled with the compensation terminal; and
a sense capacitor having a first terminal coupled with a second terminal of the sense resistor and a second terminal coupled with ground.

18. The system of claim 17, wherein the time constant of the current emulation circuit is configured to determine a modification of a compensation signal provided to the controller, wherein the compensation signal is a voltage across the compensation inductor and the compensation resistor.

19. The system of claim 18, further comprising a feedback resistor having a first terminal coupled with the second terminal of the sense resistor, configured to control a gain of the modified compensation signal.

20. The system of claim 19, further comprising a compensation capacitor having a first terminal coupled with a second terminal of the feedback resistor, configured to remove DC offset from the modified compensation signal.
